(19) United States
(12) Patent Application Publication
(10) Pub. No.: US 2019/0345593 A1
(43) Pub. Date: Nov. 14, 2019

(54) AMORPHOUS THIN METAL FILM COATED SUBSTRATES

(71) Applicant: HEWLETT-PACKARD DEVELOPMENT COMPANY, L.P., Spring, TX (US)

(72) Inventors: James Abbott, Corvallis, OR (US); Brian E Bolf, Corvallis, OR (US); Paul K Krause, Corvallis, OR (US); David Volbeda, Corvallis, OR (US)

(73) Assignee: HEWLETT-PACKARD DEVELOPMENT COMPANY, L.P., Spring, TX (US)

(21) Appl. No.: 16/343,484

(22) PCT Filed: Jan. 31, 2017
(86) PCT No.: PCT/US2017/015855

§ 371 Date: Apr. 19, 2019

(51) Int. Cl. C22C 45/10; C22C 27/02; B41J 2/16; C08L 63/00

(52) U.S. Cl. CPC C22C 45/10; C22C 27/025; C08L 63/00; B41J 2/1646; B41J 2/1606

(57) ABSTRACT

The present disclosure is drawn to an amorphous thin metal film coated substrate including a crosslinked polymer substrate and a 10 angstrom nm to 10 μm amorphous thin metal film applied directly to the crosslinked polymer substrate. The amorphous thin metal film can include from 10 at % to 50 at % of a metalloid, wherein the metalloid is carbon, silicon, boron, or a mixture thereof. The film can also include from 5 at % to 70 at % of a first metal and 5 at % to 70 at % of a second metal. The first and the second metal can be, independently, titanium, vanadium, chromium, iron, cobalt, nickel, zirconium, niobium, molybdenum, ruthenium, rhodium, palladium, hafnium, tantalum, tungsten, osmium, iridium, or platinum. The first metal and the second metal can also be from different periods of the periodic table of elements.

### BACKGROUND

Thin metal films can be used in various applications such as electronic semiconductor devices, optical coatings, and printing technologies. As such, once deposited, thin metal films can be subjected to harsh environments. For example, such thin films may be subjected to high heat, corrosive chemicals, etc.

In a typical fluid ejection device, such as an inkjet printer, the inkjet printhead ejects fluid (e.g., ink) droplets through a plurality of openings or orifices toward a print medium, such as a sheet of paper or other substrate, to print an image onto the print medium. The orifices are generally arranged in one or more arrays or patterns such that properly sequenced ejection of ink from the orifices causes characters or other images to be printed on the print medium.

### BRIEF DESCRIPTION OF THE DRAWINGS

Additional features and advantages of the present disclosure will be apparent from the detailed description which follows, taken in conjunction with the accompanying drawings, which together illustrate, by way of example, features of the present technology.

FIG. 1 shows an example schematic cross-sectional view of a distribution of elements of a three component amorphous thin metal film in accordance with the present disclosure;

FIG. 2 shows an example of a lattice structure of a three component amorphous thin metal film in accordance with the present disclosure;

FIG. 3 shows an example schematic cross-sectional view of a distribution of elements of a four component amorphous thin metal film in accordance with the present disclosure;

FIG. 4 shows an example of a lattice structure of a four component amorphous thin metal film in accordance with the present disclosure;

FIG. 5 is an example fluid ejection device including a nozzle plate coated with an amorphous thin metal film in accordance with the present disclosure;

FIG. 6 is an example fluid ejection device including a nozzle plate coated with an amorphous thin metal film in accordance with the present disclosure; and

FIG. 7 depicts an example method of preparing a nozzle plate in accordance with the present disclosure.

Reference will now be made to the examples described and illustrate herein, and specific language will be used herein to describe the same.

It will nevertheless be understood that no limitation of the scope of the present disclosure is thereby intended.

### DETAILED DESCRIPTION

As many thin metal films have a crystalline structure that possess grain boundaries and a rough surface, moving to more amorphous films can provide advantages when coating various fluid ejection device parts, including nozzle plates. Amorphous thin metal films can be very stable, having robust chemical, thermal, and mechanical properties. To illustrate these advantages using latex ink as an example, these types of inks are often designed to adhere to polymer substrates, and thus, the use of certain types of polymers for orifice plate or nozzle plate construction may have some disadvantages. For example, the latex polymer tail may diffuse into the polymer structure. Blocking this diffusion can provide for more efficient maintenance of a printhead during or after printing, leading to improved or higher fluid throughput.

In one example, an amorphous thin metal film or barrier can be applied to such polymer substrates or other substrate structures as a composite blend layer of a metalloid and multiple period 4, 5, 6, 8, 9 10 metals. To provide more amorphous films, metals can be selected for blending from different periods on the period table of elements. Using this barrier can provide many advantages, including acceptable adhesion to crosslinked polymer substrates after multiple printhead maintenance wiping cycles. In more detail, in accordance with examples of the present disclosure, an amorphous thin metal film or barrier layer, such as a TaWSi barrier for example, can be applied to a crosslinked polymer substrate to ameliorate latex diffusion from inks, and can provide for improved wiping performance on nozzle plates compared to uncoated nozzle plates.

In one example, the amorphous thin metal film coated substrate can include a crosslinked polymer substrate and a 10 angstrom to 10 μm amorphous thin metal film applied directly to the crosslinked polymer substrate. The crosslinked polymer substrate can be, for example, an epoxy-based substrate. In one specific example, the epoxy-based substrate can also be a negative photoresist, such as SU8. This material is called a “negative” photoresist material because portions that are exposed to UV energy become cross-linked, while other portions of the film that are not exposed to UV energy, e.g., masked, remain soluble and can be washed away during development. Once exposed, the epoxy groups open up and crosslink, forming a crosslinked polymer. It is noted that even though the epoxy groups are opened up and crosslinked, it is still referred to herein as a “crosslinked epoxy-based” polymer. Other crosslinked polymers that may also be suitable for use as a nozzle plate, or otherwise, can likewise be used in accordance with examples of the present disclosure.

Furthermore, the amorphous thin metal film that is coated on the crosslinked polymer substrate (which may be a nozzle plate, for example) can include from 10 at % to 50 at % of a metalloid, wherein the metalloid is carbon, silicon, boron, or a mixture thereof. The film can also include from 5 at % to 70 at % of a first metal, and 5 at % to 70 at % of a second metal, wherein the first metal and the second metal can independently be titanium, vanadium, chromium, iron, cobalt, nickel, zirconium, niobium, molybdenum, ruthenium, rhodium, palladium, hafnium, tantalum, tungsten, osmium, iridium, or platinum. The first metal and the second metal can be from different periods of the periodic table of elements. For example, the first metal can include tantalum, tungsten, nickel, or platinum (and the second metal can be from a different period than the first metal). In another example, the amorphous thin metal film can include tantalum, tungsten, and silicon. In a more detailed example, the first metal can be present at from 30 at % to 60 at %, the second metal can be present at from 10 at % to 30 at %, and the metalloid can be present at from 10 at % to 35 at %. The crosslinked polymer substrate can be a UV crosslinked epoxy-based photoresist polymer. Additionally, in one example, the thin metal amorphous film can have a thickness from 50 nm to 1 μm. Other materials may also be present in the amorphous thin metal film, such as, for example, from 0.1 at % to 25 at % of a dopant, e.g., nitrogen, oxygen, or a mixture thereof.

In another example, a fluid ejection device can include a nozzle plate, and a 50 nm to 10 μm amorphous thin metal film applied directly to the nozzle plate. The amorphous thin metal film can include from 10 at % to 50 at % of a metalloid, wherein the metalloid is carbon, silicon, boron, or a mixture thereof. The film can also include from 5 at % to 70 at % of a first metal, and from 5 at % to 70 at % of a second metal. The first metal and the second metal can independently be titanium, vanadium, chromium, iron, cobalt, nickel, zirconium, niobium, molybdenum, ruthenium, rhodium, palladium, hafnium, tantalum, tungsten, osmium, iridium, or platinum. The first metal and the second metal can also be from different periods of the periodic table of elements. In one example, the first metal can include tantalum, tungsten, nickel, or platinum (and the second metal can be from a different period). In another more specific example, the amorphous thin metal film can include tantalum, tungsten, and silicon. The nozzle plate can include or be formed of a UV crosslinked epoxy-based photoresist polymer. The thin metal amorphous film can have a thickness from 50 nm to 1 μm. Notably, other components can likewise be present in the amorphous thin metal film, such as from 0.1 at % to 25 at % of a dopant, e.g., nitrogen, oxygen, or a mixture thereof.

In another example, a method of making a nozzle plate can include depositing an amorphous thin metal film on a crosslinked polymeric nozzle plate substrate. The amorphous thin metal film can include from 10 at % to 50 at % of a metalloid, wherein the metalloid is carbon, silicon, boron, or a mixture thereof. The film can also include from 5 at % to 70 at % of a first metal, and from5 at % to 70 at % of a second metal. The first metal and the second metal can independently be titanium, vanadium, chromium, iron, cobalt, nickel, zirconium, niobium, molybdenum, ruthenium, rhodium, palladium, hafnium, tantalum, tungsten, osmium, iridium, or platinum. The first metal and the second metal can be from different periods of the periodic table of elements. In one example, the step of depositing can be by sputtering.

In accordance with the present disclosure, certain amorphous metal films can be used to coat a crosslinked polymer, which in some instances can be a nozzle plate from a fluid ejection device. With respect to thermal inkjet printheads and other MEMS device structures, there are certain structures that are exposed to harsh thermal, chemical, and/or mechanical stresses. Examples of such conditions that certain structures are exposed to include electrical isolation, abrasion, and/or flexure. Considering a nozzle plate, for example, this type of structure undergoes high temperature exposure and thermal cycling, as well as contact with harsh chemicals, etc. In one specific example, the amorphous thin metal films can be coated to crosslinked SU8 (which is a UV crosslinked epoxy polymer photoresist material) nozzle plate structures of a fluid ejection device, making the nozzle plate less susceptible to latex intrusion and improving nozzle plate wiping performance. Thus, the amorphous thin metal films disclosed herein, partially due to their substantial lack of grain boundaries, can be thermally stable at high temperatures, while retaining a metallic toughness as well as a grain free structure with an atomically smooth surface.

In further detail, the stable amorphous thin metal films described herein can include three or more components blended together. In one example, the films can include two or three metallic elements from periods 4, 5, 6, 8, 9, and 10 of the periodic table. When there are two metals, they can be from different periods on the periodic table of elements. When there are three metals, at least two can be from different periods on periodic table of elements. As mentioned, the amorphous thin metal film can also further include a metalloid, such as carbon, silicon, and/or boron. For example, it is not uncommon to include silicon and the amorphous thin metal film may also include small amounts of carbon as a result of the deposition process. However, in one specific example, the metalloid can be silicon or include silicon. As also mentioned, other components can likewise be included, such as nitrogen and/or oxygen dopant. With respect to the two or three metallic elements from periods 4, 5, 6, 8, 9, and 10 of the periodic table of elements, such metals can include tantalum (Ta), tungsten (W), nickel (Ni), platinum (Pt), molybdenum (Mo), vanadium (V), niobium (Nb), titanium (Ti), chromium (Cr), cobalt (Co), palladium (Pd), rhodium (Rh), iron (Fe), ruthenium (Ru), osmium (Os), zirconium (Zr), hafnium (Hf), or iridium (Ir). Each metal can be present in the blend at from 5 at % to 70 at %, from 10 at % to 60 at %, or from 15 at % to 50 at %. In further detail, the first metal can be present at from 30 at % to 60 at %, from 35 at % to 55 at %, or 40 at % to 45 at %; the second metal can be included at from 10 at % to 30 at %, from 10 at % to 25 at %, or about 15 at % to 20 at %; and the metalloid(s) can be included at from 10 at % to 35 at %, from 15 at % to 35 at %, or about 20 at % to 30 at %.

In one specific example, TaWSi can be prepared. Various atomic ratios of these elements can be used, but in one specific example, the Ta can be present at from 30 at % to 60 at %, from 35 at % to 55 at %, or 40 at % to 45 at %; the W can be included at from 10 at % to 30 at %, from 10 at % to 25 at %, or about 15 at % to 20 at %; and the Si can be included at from 10 at % to 35 at %, from 15 at % to 35 at %, or about 20 at % to 30 at %. These films are demonstrated to be atomically smooth, grain free structure of an amorphous material. In one example, these materials can be deposited as thin films under ambient deposition conditions with no additional post processing.

The present mixture of elements can be mixed in a manner and in quantities such that the mixture is homogenous. Additionally, the mixture can be applied to the crosslinked polymer substrate using standard deposition techniques. By using two or more metals from two or more different periods on the periodic table of elements, along with a metalloid, a “confusion” of sizes and properties disfavors the formation of lattice structures that are more typical in single component or even two component systems. This confusion can be further enhanced by selecting components with suitable size differentials to contribute to minimizing crystallization of the structure. For example, the amorphous thin metal film can have an atomic size dispersity of at least 12% between two of the plurality of elements. In another aspect, the amorphous thin metal film can have an atomic dispersity of at least 12% between all of the plurality of elements, e.g., first metal, second metal, and metalloid, etc. As used herein, “atomic dispersity” refers to the difference in size between the radii of two atoms. In one example, the atomic dispersity can be at least 15%, and in one aspect, can be at least 20%. The atomic dispersity between components can contribute to the properties of the present films, including thermal stability, oxidative stability, chemical stability, and surface smoothness, which are not achieved by typical more crystalline thin metal films.

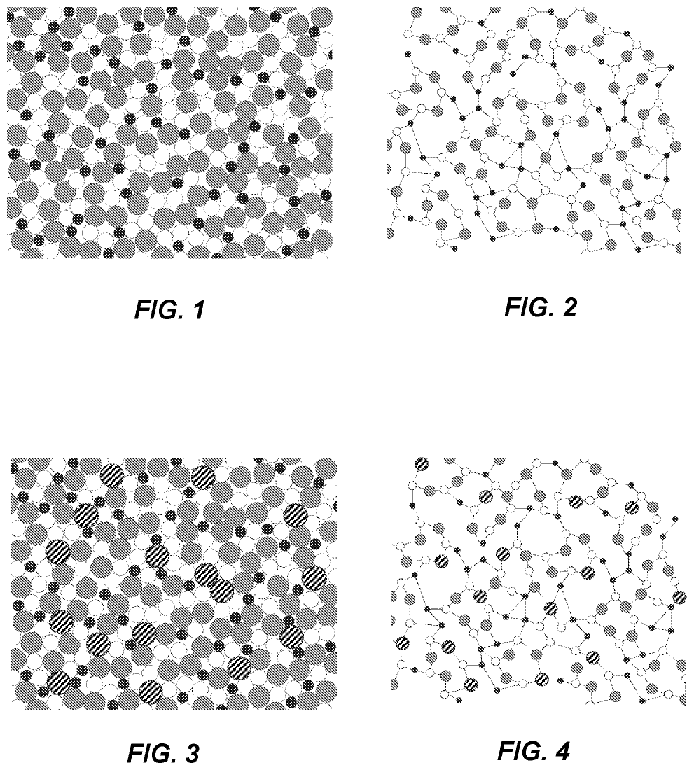

Turning now to FIG. 1, the present thin metal films can have a distribution of components with an atomic dispersity as represented in FIG. 1 when the composition is a three component film, e.g., first metal, second metal, and metalloid. Notably, the present thin metal films can be generally amorphous with a smooth, grain-free structure. The lattice structure of the three component amorphous thin metal films can be represented by FIG. 2 as compared to typical films with a more crystalline lattice structure having grain boundaries. The present thin metal films can alternatively a distribution of components with an atomic dispersity as represented in FIG. 3 when the composition is a four component film, e.g., first metal, second metal, third metal, and metalloid. Again, the present thin metal films can be generally amorphous with a smooth, grain-free structure. The lattice structure of the four component amorphous thin metal films can be represented by FIG. 4.

In additional detail regarding amorphous thin metal film properties, these films can have properties such as thermal stability, oxidative stability, and surface smoothness. In one example, the amorphous thin metal films can have a root mean square (RMS) roughness of less than 1 nm. In one aspect, the RMS roughness can be less than 0.5 nm. In another aspect, the RMS roughness can be less than 0.1 nm. One method to measure the RMS roughness includes measuring atomic force microscopy (AFM) over a 100 nm by 100 nm area. In other aspects, the AFM can be measured over a 10 nm by 10 nm area, a 50 nm by 50 nm area, or a 1 micron by 1 micron area. Other light scattering techniques can also be used such as x-ray reflectivity or spectroscopic ellipsometry.

In another example, the amorphous thin metal film can have a thermal stability of at least 400° C. In one aspect, the thermal stability can be at least 800° C. In another aspect, the thermal stability can be at least 900° C. As used herein, “thermal stability” refers to the maximum temperature that the amorphous thin metal film can be heated while maintaining an amorphous structure. One method to measure the thermal stability includes sealing the amorphous thin metal film in a quartz tube, heating the tube to a temperature, and using x-ray diffraction to evaluate the atomic structure and degree of atomic ordering.

Oxidative stability can be measured by the amorphous thin metal film's oxidation temperature and/or oxide growth rate as discussed herein. The amorphous thin metal film can have an oxidation temperature of at least 700° C. In one aspect, the oxidation temperature can be at least 800° C., and in another aspect, at least 1000° C. As used herein, the oxidation temperature is the maximum temperature that the amorphous thin metal film can be exposed before failure of the thin film due to stress creation and embrittlement of the partially or completely oxidized thin film. One method to measure the oxidation temperature is to heat the amorphous thin metal film at progressively increasing temperatures in air until the thin film cracks and flaks off the substrate. Furthermore, the amorphous thin metal film can have an oxide growth rate of less than 0.05 nm/min. In one aspect, the oxide growth rate can be less than 0.04 nm/min, or in another aspect, less than 0.03 nm/min. One method to measure the oxide growth rate is to heat the amorphous thin metal film under air (20% oxygen) at a temperature of 300° C., measure the amount of oxidation on the amorphous thin metal film using spectroscopic ellipsometry periodically, and average the data to provide a nm/min rate. Depending on the components and the method of manufacture, the amorphous thin metal film can have a wide range of electric resistivity, including ranging from 100 μΩ·cm to 2000 μΩ·cm.

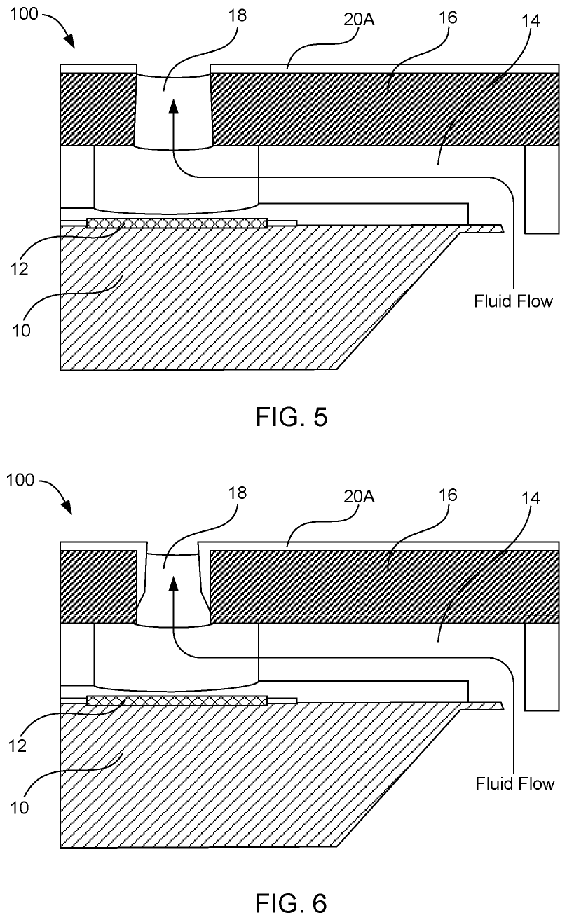

FIG. 5 and FIG. 6 show examples of fluid ejection devices100 that can be prepared in accordance with the present disclosure. Examples of fluid ejection devices include inkjet printing devices, devices used with sensors, MEMS fluid ejectors, fluid ejectors for 3D printing, etc. Thus, the fluid ejection devices can be used to eject any of a number of fluids including traditional inkjet inks or other fluids. In these examples, the fluid ejection device 100 can include a substrate 10, such as a silicon substrate. The silicon substrate can support other structures, and/or can also be used to channel ink or other fluid into channel 14 for ejection through an opening or orifice 18 of nozzle plate 16. In this example, the fluid can be ejected through the opening (or multiple openings) of the nozzle plate by the use of a resister or other jetting structure, e.g., piezo, thermal, etc., just below the opening. When the resister acts upon the fluid, it can be ejected as a small droplet through the opening. As shown specifically in FIG. 5, the nozzle plate can be coated with an amorphous thin metal film 20A. The film in this example does not extend down into the opening or orifice used to eject fluid. In one example, masking of the opening can be carried out to prevent the amorphous thin metal film from entering the opening when sputtering or otherwise coating the nozzle plate. In FIG. 6, on the other hand, the amorphous thin metal film is similarly shown at 20A, but another portion of the amorphous thin metal film 20B also extends down into the opening or orifice. Notably, though the amorphous thin metal film in FIG. 6 is shown as being present partially in the opening, it can alternatively completely cover walls of the opening, and in some examples, can also extend further down the device, coating walls of the channel (shown generally at 14).

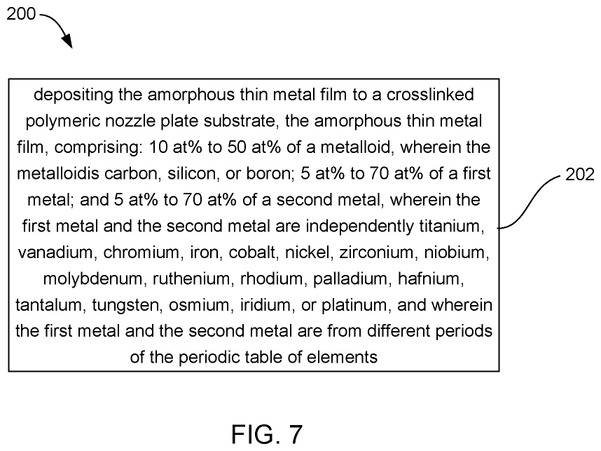

Turning now to FIG. 7, a method 200 of manufacturing a nozzle plate can include depositing 202 an amorphous thin metal film to a crosslinked polymeric nozzle plate substrate. The amorphous thin metal film can include 10 at % to 50 at % of a metalloid, wherein the metalloid is carbon, silicon, boron, or a mixture thereof. The amorphous thin metal film can also include 5 at % to 70 at % of a first metal, and 5 at % to 70 at % of a second metal, where the first metal and the second metal are independently titanium, vanadium, chromium, iron, cobalt, nickel, zirconium, niobium, molybdenum, ruthenium, rhodium, palladium, hafnium, tantalum, tungsten, osmium, iridium, or platinum. In this example, the first metal and the second metal are from different periods of the periodic table of elements.

Generally, the step of depositing can include sputtering, atomic layer deposition, chemical vapor deposition, electron beam deposition, ion beam deposition, or thermal evaporation. In one example, the depositing can be sputtering. The sputtering can generally be performed at 5 to 15 mTorr at a deposition rate of 5 to 10 nm/min with the target approximately 2 to 5 inches from a stationary substrate. Other deposition conditions may be used and other deposition rates can be achieved depending on variables such as target size, electrical power used, pressure, sputter gas, target to substrate spacing and a variety of other deposition system dependent variables. In another aspect, depositing can be performed in the presence of a dopant that is incorporated into the thin film. In another specific aspect, the dopant can be oxygen and/or nitrogen.

As used in this specification and the appended claims, the singular forms “a,” “an,” and “the” include plural referents unless the context clearly dictates otherwise.

As used herein, “devoid of” refers to the absence of materials in quantities other than trace amounts, such as impurities. For example, in one example, the amorphous thin metal film may be devoid of dopant, or devoid of carbon and boron.

The term “at %” means atomic percent.

The term “metalloid” includes semiconductor elements that are intermediate between those of metals and solid nonmetals, e.g., silicon, carbon, boron, etc.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 5 at % to about 90 at %” should be interpreted to include not only the explicitly recited values of about 5 at % to about 90 at %, but also include individual values and sub-ranges within the indicated range. Thus, included in this numerical range are individual values such as 6 at %, 7.5 at %, and 8 at %, etc., and sub-ranges such as from 5 at %-75 at %, from 7 at %-80 at %, and from 10 at %-85 at %, etc. This same principle applies to ranges reciting only one numerical value. Furthermore, such an interpretation should apply regardless of the breadth of the range or the characteristics being described.

### EXAMPLE

The following example illustrates features of the disclosure that are presently known. This example should not be considered as a limitation of the present technology, but is merely in place to teach how to make coatings and devices of the present disclosure.

Photo lithographically defined SU8 nozzle plates, such as those shown in FIGS. 5 and 6, were prepared. These nozzle plates were coated by placing a fabricated pen into a vacuum deposition chamber. In the chamber, TaWSi material was sputter deposited thereon. More specifically, three different TaWSi amorphous thin metal film samples were prepared having the Ta:W:Si at % ratios shown in Table 1 below.

TABLE 1

| a) Deposition Pressure; | | Oxygen | Silicon | Tantalum | Tungsten |
|---|---|---|---|---|---|
| b) Power; c) Target; | Carbon (at %) | (at %) | (at %) | (at %) | (at %) |
| d) Thickness | C1s | O1s | Si2p.AMMF | Ta4f | W4f |
| a) 5 mT; b) 200 W; | 2.3 | 3.8 | 16.8 | 51.2 | 26 |
| c) 3 inch; d) 0.9 μm | | | | | |
| a) 10 mT; b) 200 W; | 2.8 | 0 | 23 | 49.9 | 24.3 |
| c) 3 inch; d) 0.9 μm | | | | | |
| a) 10 mT; b) 100 W; | 2.6 | 0 | 23.6 | 49.7 | 24.1 |
| c) 3 inch; d) 0.9 μm | | | | | |

The carbon and oxygen values reported may vary and are not always present.

Each of the above samples shown in Table 1 exhibited good adhesion and robustness on the crosslinked SU8 polymer after aggressive wiping that removed ink crust. Additionally, it was observed that there was qualitatively less crust build up based on visual inspection. Still further, evidence indicated that the crosslinked SU8 nozzle plate coated with the TaWSi allowed for efficient removal of latex crust during routine wiping.

While the present technology has been described with reference to certain examples, those skilled in the art will appreciate that various modifications, changes, omissions, and substitutions can be made without departing from the spirit of the present technology. It is intended, therefore, that the present technology be limited only by the scope of the following claims.

What is claimed is:

1. An amorphous thin metal film coated substrate, comprising:
a crosslinked polymer substrate; and
a 10 angstrom to 10 μm amorphous thin metal film applied directly to the crosslinked polymer substrate, wherein the amorphous thin metal film comprises:
10 at % to 50 at % of a metalloid, wherein the metalloid is carbon, silicon, boron, or a mixture thereof,
5 at % to 70 at % of a first metal, and
5 at % to 70 at % of a second metal,
wherein the first metal and the second metal are independently titanium, vanadium, chromium, iron, cobalt, nickel, zirconium, niobium, molybdenum, ruthenium, rhodium, palladium, hafnium, tantalum, tungsten, osmium, iridium, or platinum, and
wherein the first metal and the second metal are from different periods of the periodic table of elements.

2. The amorphous thin metal film coated substrate of claim 1, wherein the first metal includes tantalum, tungsten, nickel, or platinum.

3. The amorphous thin metal film coated substrate of claim 1, wherein the amorphous thin metal film comprises tantalum, tungsten, and silicon.

4. The amorphous thin metal film coated substrate of claim 1, wherein the first metal is present at from 30 at % to 60 at %, the second metal is present at from 10 at % to 30 at %, and the metalloid is present at from 10 at % to 35 at %.

5. The amorphous thin metal film coated substrate of claim 1, wherein the crosslinked polymer substrate is a crosslinked epoxy-based polymer.

6. The amorphous thin metal film coated substrate of claim 1, wherein the amorphous thin metal film further comprises a third metal selected from titanium, vanadium, chromium, iron, cobalt, nickel, zirconium, niobium, molybdenum, ruthenium, rhodium, palladium, hafnium, tantalum, tungsten, osmium, iridium, or platinum, wherein the third metal is different than the first metal and the second metal.

7. The amorphous thin metal film coated substrate of claim 1, further comprising 0.1 at % to 25 at % of a dopant, wherein the dopant is nitrogen, oxygen, or a mixture thereof.

8. The amorphous thin metal film coated substrate of claim 1, wherein the amorphous thin metal film has a thermal stability of at least 400° C., an oxidation stability with an oxidation temperature of at least 700° C. and an oxide growth rate of less than 0.05 nm/min, and a root mean square roughness of less than 1 nm.

9. A fluid ejection device, comprising:
a nozzle plate; and
a 50 nm to 10 μm amorphous thin metal film applied directly to the nozzle plate, wherein the amorphous thin metal film comprises:
10 at % to 50 at % of a metalloid, wherein the metalloid is carbon, silicon, boron, or a mixture thereof,
5 at % to 70 at % of a first metal, and
5 at % to 70 at % of a second metal,
wherein the first metal and the second metal are independently titanium, vanadium, chromium, iron, cobalt, nickel, zirconium, niobium, molybdenum, ruthenium, rhodium, palladium, hafnium, tantalum, tungsten, osmium, iridium, or platinum, and
wherein the first metal and the second metal are from different periods of the periodic table of elements.

10. The fluid ejection device of claim 9, wherein the first and second metal independently include tantalum, tungsten, nickel, or platinum, and the metalloid includes silicon.

11. The fluid ejection device of claim 9, wherein the nozzle plate comprises a crosslinked epoxy-based polymer.

12. The fluid ejection device of claim 9, wherein the amorphous thin metal film further comprises a third metal selected from titanium, vanadium, chromium, iron, cobalt, nickel, zirconium, niobium, molybdenum, ruthenium, rhodium, palladium, hafnium, tantalum, tungsten, osmium, iridium, or platinum, wherein the third metal is different than the first metal and the second metal.

13. The fluid ejection device of claim 9, further comprising 0.1 at % to 25 at % of a dopant, wherein the dopant is nitrogen, oxygen, or a mixture thereof.

14. A method of making a nozzle plate, comprising depositing the amorphous thin metal film to a crosslinked polymeric nozzle plate substrate, the amorphous thin metal film, comprising:
10 at % to 50 at % of a metalloid, wherein the metalloid is carbon, silicon, boron, or a mixture thereof,
5 at % to 70 at % of a first metal, and
5 at % to 70 at % of a second metal,
wherein the first metal and the second metal are independently titanium, vanadium, chromium, iron, cobalt, nickel, zirconium, niobium, molybdenum, ruthenium, rhodium, palladium, hafnium, tantalum, tungsten, osmium, iridium, or platinum, and
wherein the first metal and the second metal are from different periods of the periodic table of elements.

15. The method of claim 7, wherein depositing includes sputtering.
